(19) United States
(12) Patent Application Publication
(10) Pub. No.: US 2022/0138590 A1
(43) Pub. Date: May 5, 2022

(54) MODEL CONSTRUCTION SYSTEM, MODEL CONSTRUCTION APPARATUS, AND MODEL CONSTRUCTION METHOD

(71) Applicant: Institute For Information Industry, Taipei (TW)

(72) Inventors: Pei-Yuan TSAI, Taipei (TW); Yu-Cheng TSAI, Taipei (TW); Zhi-Guo ZHU, Taipei (TW); Ping-Che YANG, Taipei (TW); Chih-Shan LUO, Taipei (TW)

(21) Appl. No.: 17/107,625

(22) Filed: Nov. 30, 2020

(30) Foreign Application Priority Data
Nov. 5, 2020 (TW) 109138577

(51) Int. Cl. G06N 5/02; G06N 20/00

(52) U.S. Cl. CPC G06N 5/02; G06Q 40/025; G06N 20/00

(57) ABSTRACT

A model construction system, apparatus, and method are provided. The model construction system includes at least one first source apparatus, at least one second source apparatus, and a model construction apparatus. The model construction apparatus receives a de-identification data set from each first source apparatus, receives a parameter set of a source model from each second source apparatus, generates at least one aligned data set by aligning the de-identification data set according to a predetermined data format, trains an original model to an assisted training model with the aligned data set(s), generates at least one updated parameter set according to the parameter set(s) and an assisted training parameter set, updates the assisted training model with one of the updated parameter set(s), and transmits the updated parameter set(s) to the second source apparatus(es). Each second source apparatus updates the source model according to the corresponding updated parameter set.

### PRIORITY

This application claims priority to Taiwan Patent Application No. 109138577 filed on Nov. 5, 2020, which is hereby incorporated by reference in its entirety.

### FIELD

The present invention relates to a model construction system, a model construction apparatus, and a model construction method. Specifically, the present invention relates to a system, apparatus, and method that construct models by using data sets and parameter sets of models from multiple sources.

### BACKGROUND

With the advent of the era of big data, more and more enterprises collect various data to construct models in different application fields and then use the constructed models to make business decisions (for example, some banks construct models based on users' deposits and consumption behaviors and then use the constructed models to decide whether to grant users loans on credit). However, the breadth and depth of data belonging to enterprises themselves are quite limited. In terms of breadth, any enterprise only has data of some aspects (for example, a bank only has user's data such as deposits, loans, credit limits and does not have user's consumption behaviors, tickets payment). In terms of depth, the amount of data owned by any enterprise is only a very small part of the vast data (for example, the banking industry only has the data of some users, but not all users). Therefore, combining data of various parties (e.g., cross-disciplinary and cross-unit) to make more accurate decisions and create more values is the future trend.

Data owners can be roughly divided into two categories. The first category data owners have their own models (for example, they are capable of constructing models, so they can train models that they want to use). However, when these data owners use their own data to construct models, they often find that some key data are unavailable and, thus, the constructed models are not accurate enough. The second category data owners do not have their own models (for example, they are incapable of constructing models and, thus, they cannot train models that they want to use), so they have no idea of how to utilize the large amount of data that they have. No matter which category data owners, the data owned by them often has personal identities (such as names, ID numbers) or other information that needs to be protected (such as addresses, incomes). Thus, data cannot be released arbitrarily.

Accordingly, there is an urgent need for a technique that can construct a more accurate model by using data of different data owners without infringing personal data.

### SUMMARY

An objective of certain embodiments of the present invention is to provide a model construction system. The model construction system in certain embodiments may comprise at least one first source apparatus, at least one second source apparatus, and a model construction apparatus. Each of the at least one first source apparatus has a de-identification data set, and each of the at least one second source apparatus has a source model. The model construction apparatus receives the corresponding de-identification data set from each of the at least one first source apparatus and receives a parameter set of the corresponding source model from each of the at least one second source apparatus. The model construction apparatus generates at least one aligned data set by aligning the at least one de-identification data set according to a predetermined data format and trains an original model into an assisted training model with the at least one aligned data set. The model construction apparatus generates at least one updated parameter set according to the at least one parameter set and an assisted training parameter set of the assisted training model and updates the assisted training model with one of the at least one updated parameter set. The model construction apparatus transmits one of the at least one updated parameter set to each of the at least one second source apparatus. Each of the at least one second source apparatus updates the corresponding source model according to the corresponding updated parameter set. The at least one source model, the original model, and the assisted training model all conform to a predetermined architecture.

An objective of certain embodiments of the present invention is to provide a model construction apparatus. The model construction apparatus in certain embodiments may comprise a transceiving interface and a processor, wherein the processor is electrically connected to the transceiving interface. The transceiving interface receives a de-identification data set from each of at least one first source apparatus and receives a parameter set of a source model from each of at least one second source apparatus. The processor generates at least one aligned data set by aligning the at least one de-identification data set according to a predetermined data format and trains an original model into an assisted training model by the at least one aligned data set. The processor generates at least one updated parameter set according to the at least one parameter set and an assisted training parameter set of the assisted training model and updates the assisted training model by one of the at least one updated parameter set. The transceiving interface further transmits one of the at least one updated parameter set to each of the at least one second source apparatus so that each of the at least one second source apparatus updates the corresponding source model according to the corresponding updated parameter set. The at least one source model, the original model, and the assisted training model all conform to a predetermined architecture.

An objective of certain embodiments of the present invention is to provide a model construction method. The model construction method in certain embodiments may comprise the following steps: (a) receiving, by a model construction apparatus, a de-identification data set from each of at least one first source apparatus, (b) receiving, by the model construction apparatus, a parameter set of a source model from each of at least one second source apparatus, (c) generating, by the model construction apparatus, at least one aligned data set by aligning the at least one de-identification data set according to a predetermined data format to generate at least one aligned data set, (d) training, by the model construction apparatus, an original model into an assisted training model with the at least one aligned data set, (e) generating, by the model construction apparatus, at least one updated parameter set according to the at least one parameter set and an assisted training parameter set of the assisted training model, (f) updating, by the model construction apparatus, the assisted training model with one of the at least one updated parameter set, (g) transmitting, by the model construction apparatus, one of the at least one updated parameter set to each of the at least one second source apparatus, and (h) updating, by each of the at least one second source apparatus, the corresponding source model according to the corresponding updated parameter set. The at least one source model, the original model, and the assisted training model all conform to a predetermined architecture.

The model construction technology provided according to the present invention (at least including the system, apparatus, and method) utilizes a de-identification data set of each of at least one first source apparatus (i.e., the data owner incapable of constructing models) and a parameter set of a source model of each of at least one second source apparatus (i.e., the data owner capable of constructing models) to construct models. Specifically, the model construction technology provided according to the present invention generates at least one aligned data set by aligning the at least one de-identification data set according to a predetermined data format and trains an original model into an assisted training model with the at least one aligned data set. The model construction technology provided according to the present invention further generates at least one updated parameter set according to the at least one parameter set and an assisted training parameter set of the assisted training model and updates the assisted training model with one of the at least one updated parameter set. The model construction technology provided according to the present invention further provides the at least one updated parameter set to the at least one second source apparatus so that each of the at least one second source apparatus updates the corresponding source model according to the corresponding updated parameter set.

Through the aforesaid operations/steps, the at least one first source apparatus can use the assisted training model, and the assisted training model and the at least one source model of the at least one second source apparatus use data of each other when being updated. Therefore, the model construction technology provided according to the present invention can construct a more accurate model by using data of different data owners without infringing personal data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a schematic view of a model construction system 1 according to some embodiments of the present invention;

FIG. 2A, FIG. 2B, and FIG. 2C depict schematic views of original data sets D1, D2, and D3 in a specific application example of the present invention; and

FIG. 3 depicts a flowchart of a model construction method according to some embodiments of the present invention.

### DETAILED DESCRIPTION

In the following description, examples of a model construction system, a model construction apparatus, and a model construction method are provided and explained with reference to example embodiments thereof. However, these example embodiments are not intended to limit the present invention to any specific environment, example, applications, or implementations described in these example embodiments. Therefore, description of these example embodiments is only for purpose of illustration rather than to limit the scope of the present invention.

It shall be appreciated that, in the following embodiments and the attached drawings, elements unrelated to the present invention are omitted from depiction. In addition, dimensions of elements and dimensional proportions among individual elements in the attached drawings are provided only for ease of depiction and illustration, but not to limit the scope of the present invention.

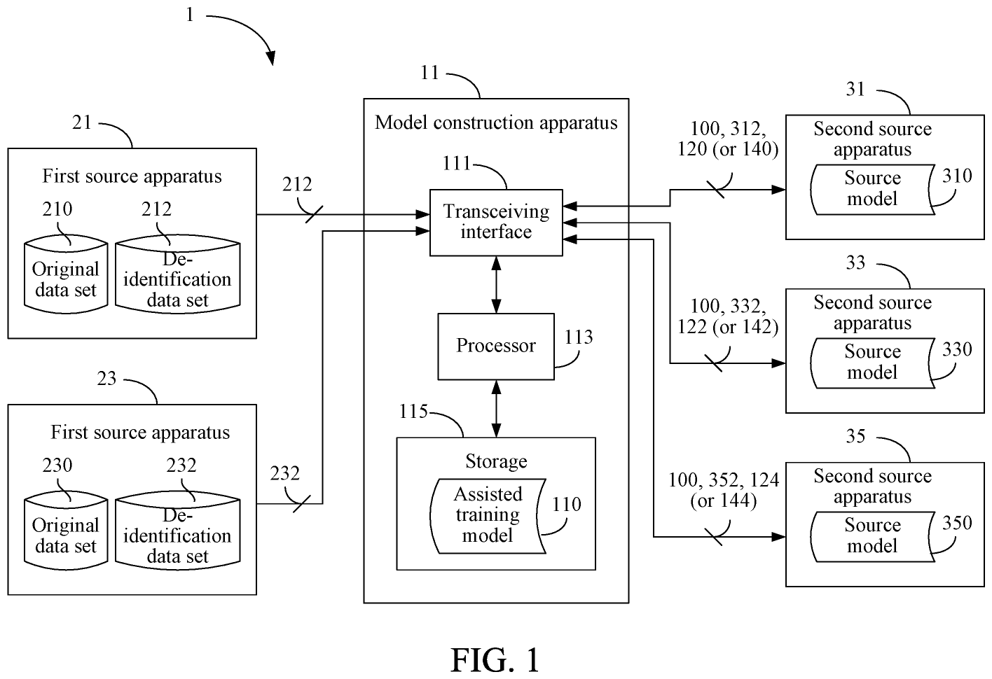

A first embodiment of the present invention is a model construction system 1 and a schematic view of which is depicted in FIG. 1. The model construction system 1 comprises a model construction apparatus 11, two first source apparatuses 21 and 23, and three second source apparatuses 31, 33, and 35. The model construction apparatus 11 may be a server, a workstation computer, or other computers/computing machines with sufficient computing capability, the first source apparatuses 21 and 23 are computer apparatuses of data owners having data but incapable of model construction, and the second source apparatuses 31, 33 and 35 are computer apparatuses of data owners capable of model construction. It shall be noted that the number of the first source apparatuses and the number of the second source apparatuses described above are only examples. The number of the first source apparatuses in a model construction system is not limited in the present invention as long as it is a positive integer. Similarly, the number of the second source apparatuses in a model construction system is not limited as long as it is a positive integer.

The model construction apparatus 11 comprises a transceiving interface 111 and a processor 113, and the processor 113 is electrically connected to the transceiving interface 111. The transceiving interface 111 may be a wired transmission interface or a wireless transmission interface known to a person having ordinary skill in the art, which is used to be connected to a network (e.g., an Internet, a local area network) and may receive and transmit signals and data on the network. The processor 113 may be one of the various processors, central processing units (CPUs), microprocessor units (MPUs), digital signal processors (DSPs), or other computing apparatuses well-known to a person having ordinary skill in the art. The model construction apparatus 11 may further comprise a storage 115 for storing an assisted training model 110, various data sets, or/and various parameter sets during operations. The storage 115 may be a memory, a universal serial bus (USB) disk, a mobile disk, a compact disk (CD), a digital versatile disc (DVD), a hard disk drive (HDD), or any other non-transitory storage medium or apparatus with the same function and well-known to a person having ordinary skill in the art.

In this embodiment, the model construction apparatus 11 will assist the first source apparatuses 21 and 23 in training an original model (not shown) into an assisted training model 110 and will assist the second source apparatuses 31, 33, and 35 in training source models 310, 330, and 350 respectively belonging to the second source apparatuses 31, 33, and 35. The aforementioned original model, assisted training model 110, and source models 310, 330, and 350 all conform to the same predetermined architecture, and the predetermined architecture may be the architecture of any model (for example, the architecture of any kind of machine learning model) that can be trained by data to achieve a certain purpose (e.g., identification or analysis). In this embodiment, the second source apparatuses 31, 33, and 35 do not know a predetermined architecture 100 of the model to be adopted by the model construction apparatus 11 before cooperating with the model construction apparatus 11, so the transceiving interface 111 of the model construction apparatus 11 transmits the predetermined architecture 100 to the second source apparatuses 31, 33, and 35. In some embodiments, if the second source apparatuses 31, 33, and 35 already know the predetermined architecture of the model to be adopted by the model construction apparatus 11 before cooperating with the model construction apparatus 11, the transceiving interface 111 of the model construction apparatus 11 does not need to transmit the predetermined architecture 100 to the second source apparatuses 31, 33, and 35.

How the model construction apparatus 11 cooperates with the first source apparatuses 21 and 23 and the second source apparatuses 31, 33, and 35 to train the assisted training model 110 and the source models 310, 330, and 350 by using all data sets will be described in detail in the following descriptions.

The first source apparatuses 21 and 23 respectively have the de-identification data sets 212 and 232 that may be provided for use by others and no specific personal information can be identified therefrom. In some embodiments, the first source apparatuses 21 and 23 respectively perform at least one transformation on the original data sets 210 and 230 (which may have specific personal information) to generate the de-identification data sets 212 and 232. For example, a first source apparatus (which may be the first source apparatus 21 and/or the first source apparatus 23) may transform its own original data set into a first coordinate space (not shown) to generate a first transformed data set (not shown) and then take the first transformed data set as the first de-identification data set. For another example, a first source apparatus (which may be the first source apparatus 21 and/or the first source apparatus 23) may transform its own original data set into a first coordinate space to generate a first transformed data set, transform the first transformed data set into a second coordinate space for the second time to generate a second transformed data set, and then take the second transformed data set as the de-identification data set.

It shall be noted that any transformation performed by the first source apparatus may comprise projection, sampling, encoding, or/and perturbation. In addition, the way that the first source apparatus 21 transforms the original data set 210 into the de-identification data set 212 may be the same as or different from the way that the first source apparatus 23 transforms the original data set 230 into the de-identification data set 232.

The transceiving interface 111 of the model construction apparatus 11 receives the de-identification data sets 212 and 232 from the first source apparatuses 21 and 23 respectively. Since the de-identification data sets 212 and 232 come from different apparatuses, the items of data comprised therein may be different and the recording format and/or the unit(s) of data may be different. In order to train an accurate assisted training model 110, the processor 113 of the model construction apparatus 11 generates an aligned data set of each of the de-identification data sets 212 and 232 by aligning each of the de-identification data sets 212 and 232 according to a predetermined data format. For example, the processor 113 of the model construction apparatus 11 may perform one or more of the following operations: (a) determining a field name of each of at least one field comprised in each of the de-identification data sets 212 and 232 according to the predetermined data format, (b) normalizing a plurality of pieces of data comprised in each of the de-identification data sets 212 and 232 according to the predetermined data format, and (c) aligning a plurality of timestamps of the pieces of data comprised in each of the de-identification data sets 212 and 232. Next, the processor 113 of the model construction apparatus 11 trains an original model into the assisted training model 110 with the aligned data sets.

The second source apparatuses 31, 33, and 35 respectively have the source models 310, 330, and 350 which conform to the predetermined architecture. The second source apparatuses 31, 33, and 35 are capable of constructing models, so the second source apparatuses 31, 33, and 35 may train the source models 310, 330, and 350 with their own original data sets respectively. The transceiving interface 111 of the model construction apparatus 11 receives the parameter sets 312, 332, and 352 of the source models 310, 330, and 350 from the second source apparatuses 31, 33, and 35 respectively. Then, the processor 113 of the model construction apparatus 11 generates at least one updated parameter set (not shown) according to the parameter sets 312, 332, and 352 and an assisted training parameter set (not shown) of the assisted training model 110. The processor 113 of the model construction apparatus 11 then updates the assisted training model 110 with one of the at least one updated parameter set. In addition, the transceiving interface 111 of the model construction apparatus 11 transmits one of the at least one updated parameter set to the second source apparatuses 31, 33, and 35 individually. Then, the second source apparatuses 31, 33, and 35 updates the corresponding source models 310, 330, and 350 according to the corresponding updated parameter set.

For comprehension, a specific example is given for a detailed description. In this specific example, the predetermined architecture adopted by the model construction apparatus 11 is an architecture of a machine learning model, and the model construction apparatus 11 adopts horizontal federated learning. The parameter sets 312, 332, and 352 received by the transceiving interface 111 of the model construction apparatus 11 from the second source apparatuses 31, 33, and 35 respectively are all gradients or a part of gradients of the source models 310, 330, and 350 respectively. The processor 113 of the model construction apparatus 11 generates an updated parameter set 120 according to the parameter sets 312, 332, and 352 and the assisted training parameter set of the assisted training model 110, and the updated parameter sets 120, 122, and 124 comprise a plurality of aggregated gradients. The processor 113 of the model construction apparatus 11 updates the assisted training model 110 with the updated parameter set 120, and the transceiving interface 111 of the model construction apparatus 11 transmits the updated parameter sets 120, 122, and 124 to the second source apparatuses 31, 33, and 35 respectively. The second source apparatuses 31, 33, and 35 then update the source models 310, 330, and 350 according to the updated parameter sets 120, 122, and 124 respectively. In some embodiments, the updated parameter sets 120, 122, and 124 may be the same parameter set.

Here, another specific example is given for a detailed description. In this specific example, the predetermined architecture adopted by the model construction apparatus 11 is an architecture of a machine learning model, and the model construction apparatus 11 adopts vertical federated learning. The parameter sets 312, 332, and 352 received by the transceiving interface 111 of the model construction apparatus 11 from the second source apparatuses 31, 33, and 35 respectively are all gradients or a part of gradients of the source models 310, 330, and 350 respectively. The parameter sets 312, 332, and 352 may further comprise a loss value. The processor 113 of the model construction apparatus 11 generates a plurality of updated parameter sets according to the parameter sets 312, 332, and 352 and the assisted training parameter set of the assisted training model 110. The processor 113 of the model construction apparatus 11 updates the assisted training model 110 with one of the plurality of updated parameter sets. The transceiving interface 111 of the model construction apparatus 11 transmits the updated parameter sets 140, 142, and 144 to the second source apparatuses 31, 33, and 35 respectively so that the second source apparatuses 31, 33, and 35 update the source models 310, 330, and 350 according to the updated parameter sets 140, 142, and 144 respectively.

Thereafter, if the transceiving interface 111 of the model construction apparatus 11 receives other de-identification data sets from the first source apparatuses 21 and 23 individually, the processor 113 of the model construction apparatus 11 generate an aligned data set of each of the de-identification data sets by aligning each of the de-identification data sets received at this time according to the predetermined data format and then continues to train the assisted training model 110 with the aligned data set generated at this time. In addition, if the transceiving interface 111 of the model construction apparatus 11 receives updated parameter sets of the source models 310, 330, and 350 from the second source apparatuses 31, 33, and 35 respectively, then processor 113 of the model construction apparatus 11 generates at least one updated parameter set according to the parameter sets of the source models 310, 330, and 350 received at this time and the assisted training parameter set of the assisted training model 110 and then updates the assisted training model 110 with one of the updated parameter sets generated at this time. The transceiving interface 111 of the model construction apparatus 11 transmits one of the updated parameter sets generated at this time to each of the second source apparatuses 31, 33, and 35 individually so that the second source apparatuses 31, 33, and 35 respectively update the source models 310, 330, and 350 according to the corresponding updated parameter sets. According to the above descriptions, a person having ordinary skill in the art shall appreciate that the model construction apparatus 11 may repeat the aforesaid operations continuously to improve the accuracy of the assisted training model 110 and the source models 310, 330, and 350. Thus, the details will not be further described herein.

In this embodiment, in order to avoid information leakage, the parameter sets 312, 332, and 352 and the updated parameter sets 120, 140, 142, and 144 are transmitted between the model construction apparatus 11 and the corresponding second source apparatuses 31, 33, and 35 in an encrypted mode. In other embodiments, if the model construction apparatus 11, the first source apparatuses 21, 23, and the second source apparatuses 31, 33, and 35 are deployed in an information secure environment, the parameter sets 312, 332, and 352 and the updated parameter sets 120, 140, 142, and 144 may be transmitted between the model construction apparatus 11 and the corresponding second source apparatuses 31, 33, and 35 in an unencrypted mode.

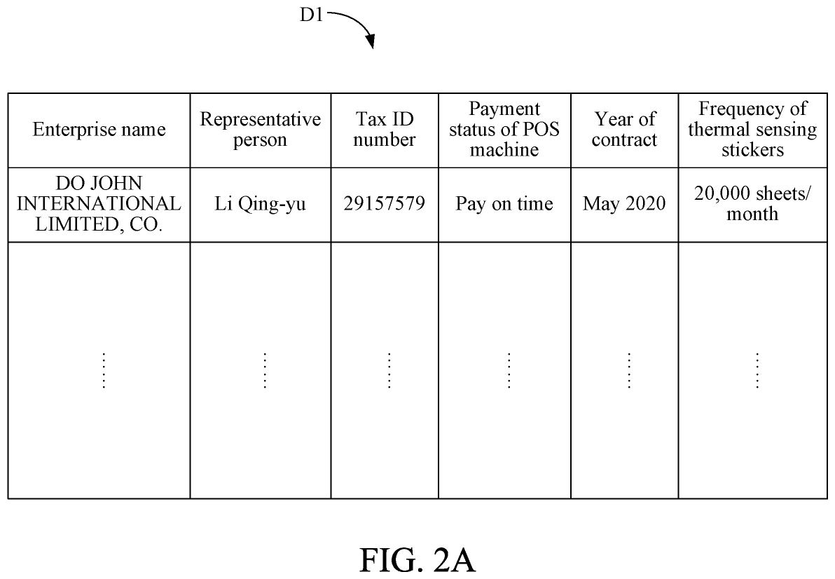

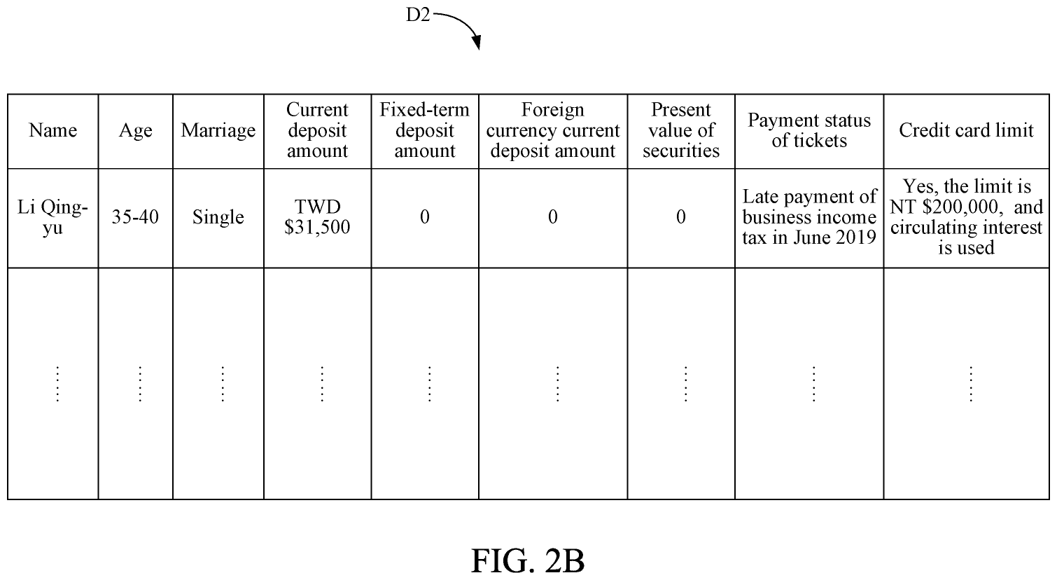

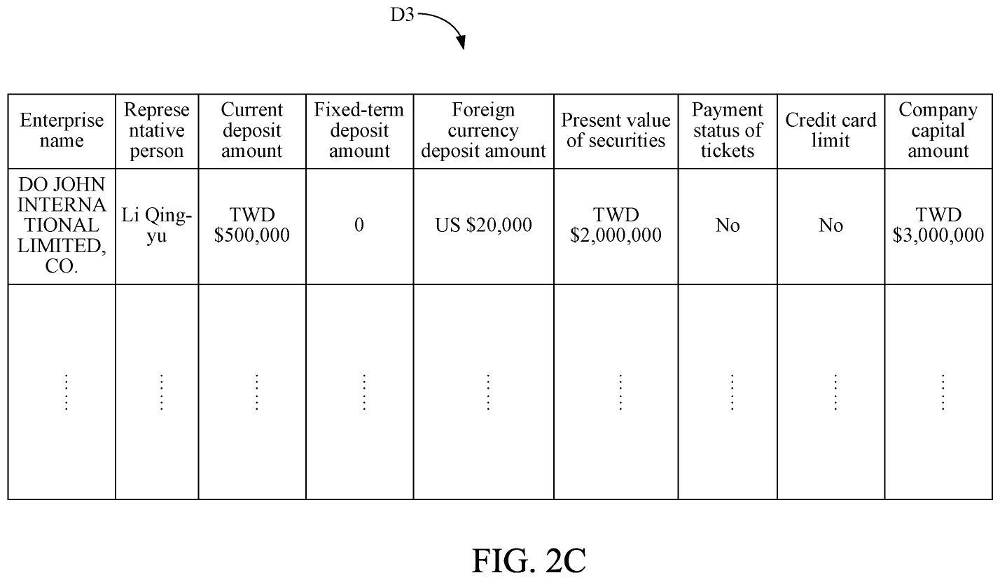

To understand the specific effects that the model construction system 1 can achieve, a specific exemplary application is provided herein. In this specific exemplary application, the model construction system 1 comprises a model construction apparatus 11, a first source apparatus, and two second source apparatuses. The first source apparatus belongs to a website company, which is incapable of constructing models but has the original data set D1 as shown in FIG. 2A. The two second source apparatuses are capable of constructing models and belong to a first bank and a second bank respectively. The second source apparatus belonging to the first bank has the original data set D2 as shown in FIG. 2B, while the second source apparatus belonging to the second bank has the original data set D3 as shown in FIG. 2C. For the case that a user (e.g., the user named “Li Qing-yu”) applies for a loan on credit, the conventional technology and the model construction system 1 of the present invention provide different results.

According to the conventional technology, the first bank may use the original data set D2 of its own to establish a first credit model. However, due to the limited depth and breadth of the original data set D2, the first credit model cannot make a more accurate decision when evaluating whether to grant the user “Li Qing-yu” loan on credit. Similarly, according to the conventional technology, the second bank may use the original data set D3 of its own to establish a second credit model. However, due to the limited depth and breadth of the original data set D3, the second credit model also cannot make a more accurate decision when evaluating whether to grant the user “Li Qing-yu” loan on credit.

If the model construction system 1 of the present invention is adopted, the model construction apparatus 11 will use the de-identification data set provided by the first source apparatus (i.e., the de-identification data set obtained by transforming the original data set D1) to train an assisted training model, generate at least one updated parameter set according to an assisted training parameter set of the assisted training model, the parameter set of the first credit model of the first bank, and the parameter set of the second credit model of the second bank, and then update the assisted training model, the first credit model, and the second credit model with these updated parameter sets. Therefore, all of the assisted training model, the first credit model, and the second credit model indirectly use all the original data sets D1, D2, and D3 when being updated. Since the breadth and depth of the original data set used by the model construction system 1 are greatly increased, the assisted training model, the first credit model, and the second credit model can all make more accurate decisions.

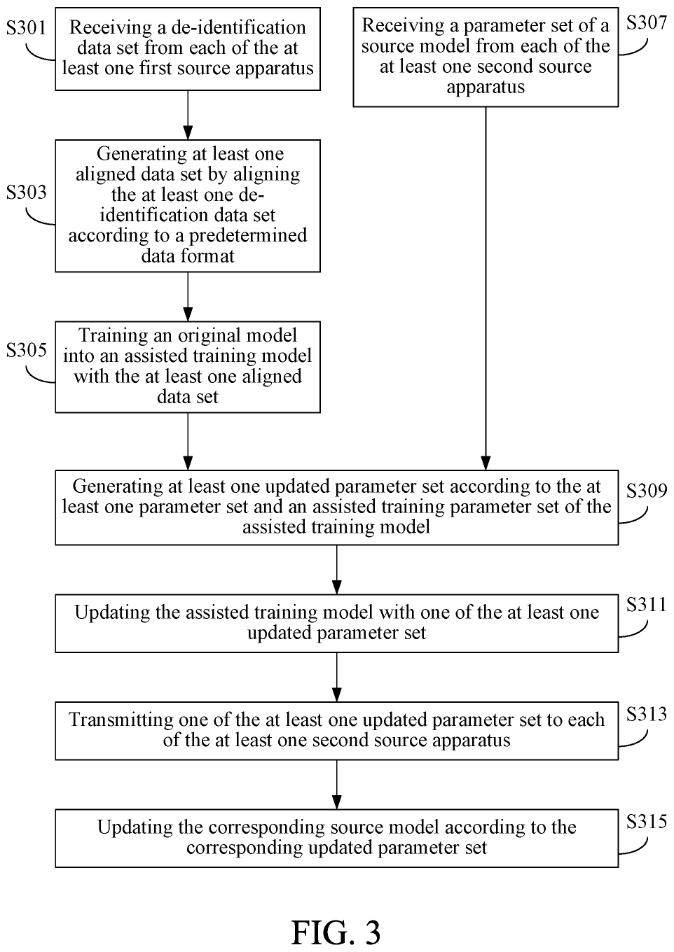

A second embodiment of the present invention is a model construction method, and a main flowchart thereof is depicted in FIG. 3. The model construction method is adapted for use in a model construction system (e.g., the model construction system 1 in the aforesaid embodiment), wherein the model construction system comprises a model construction apparatus, at least one first source apparatus, and at least one second source apparatus. In this embodiment, the model construction method comprises steps S301 to S315.

At the step S301, the model construction apparatus receives a de-identification data set from each of the at least one first source apparatus. In some embodiments, before the step S301, each of the at least one first source apparatus executes a step to transform an original data set into a first coordinate space to generate a transformed data set and then takes the transformed data set as the de-identification data set. In some embodiments, before the step S301, each of the at least one first source apparatus executes a step to transform an original data set into a first coordinate space to generate a first transformed data set, executes a step to transform the first transformed data set into a second coordinate space for the second time to generate a second transformed data set, and then takes the second transformed data set as the de-identification data set.

At the step S303, the model construction apparatus generates at least one aligned data set by aligning the at least one de-identification data set according to a predetermined data format. In some embodiments, the step S303 generates the corresponding aligned data set by executing the following steps on each of the at least one de-identification data set: (a) determining a field name of each of at least one field comprised in the first de-identification data set according to the predetermined data format, (b) normalizing a plurality of pieces of data comprised in the first de-identification data set according to the predetermined data format, and (c) aligning a plurality of timestamps of the pieces of data. Then, in the step S305, the model construction apparatus trains an original model into an assisted training model with the at least one aligned data set.

In addition, in the step S307, the model construction apparatus receives a parameter set of a source model from each of the at least one second source apparatus. It shall be noted that the order for executing the steps S301 to S305 and the step S307 are not limited in the present invention. In other words, the model construction method may execute the step S307 and then execute the steps S301 to S305, may execute the steps S301 to S305 and then execute the step S307, or may execute the step S307 while executing the steps S301 to S305.

At the step S309, the model construction apparatus generates at least one updated parameter set according to the at least one parameter set and an assisted training parameter set of the assisted training model. Then, at the step S311, the model construction apparatus updates the assisted training model with one of the at least one updated parameter set. At the step S313, the model construction apparatus transmits one of the at least one updated parameter set to each of the at least one second source apparatus. It shall be noted that the order for executing the step S311 and the step S313 is not limited in the present invention. In other words, the model construction method may execute the step S311 and then execute the step S313, may execute the steps S313 and then execute the step S311, or may execute the step S311 and the step S313 at the same time. At the step S315, each of the at least one second source apparatus updates the corresponding source model according to the corresponding updated parameter set.

It shall be noted that, in this embodiment, the at least one source model, the original model, and the assisted training model all conform to a predetermined architecture. It shall be additionally noted that the model construction method may repeatedly execute the steps S301 to S315 to improve the accuracy of the assisted training model and the at least one source model, and this will not be repeated herein.

In addition to the aforesaid steps, the second embodiment can also execute all the operations and steps that can be executed by the model construction system 1, have the same functions, and deliver the same technical effects as the model construction system 1. How the second embodiment executes these operations and steps, has the same functions, and delivers the same technical effects as the model construction system 1 will be readily appreciated by a person having ordinary skill in the art based on the above explanation of the model construction system 1, and thus will not be further described herein.

It shall be noted that, in the specification and the claims of the present invention, some words (including source apparatus, de-identification data set, parameter set, aligned data set, assisted training parameter set, updated parameter set, coordinate space, transformed data set) are preceded by terms such as “first” or “second,” and these terms of “first” and “second” are used to distinguish these words from each other.

According to the above descriptions, the model construction technology provided according to the present invention (at least including the system, apparatus, and method) uses a de-identification data set of each of at least one first source apparatus (i.e., the data owner incapable of constructing models) and a parameter set of a source model of each of at least one second source apparatus (i.e., the data owner capable of constructing models) to construct models. Specifically, the model construction technology provided according to the present invention generates at least one aligned data set by aligning the at least one de-identification data set according to a predetermined data format and trains an original model into an assisted training model with the at least one aligned data set. The model construction technology provided according to the present invention further generates at least one updated parameter set according to the at least one parameter set and an assisted training parameter set of the assisted training model and updates the assisted training model with one of the at least one updated parameter set. The model construction technology provided according to the present invention further provides the at least one updated parameter set to the at least one second source apparatus so that each of the at least one second source apparatus updates the corresponding source model according to the corresponding updated parameter set.

Through the aforesaid operations/steps, the at least one first source apparatus has the corresponding assisted training model for use, and the assisted training model and the at least one source model of the at least one second source apparatus use data of each other when being updated. Therefore, the model construction technology provided by the present invention can construct a more accurate model by using data of different data owners without infringing personal data.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A model construction apparatus, comprising:
a transceiving interface, being configured to receive a first de-identification data set from each of at least one first source apparatus and receive a first parameter set of a source model from each of at least one second source apparatus; and
a processor, being electrically connected to the transceiving interface, and being configured to generate at least one first aligned data set by aligning the at least one first de-identification data set according to a predetermined data format, train an original model into an assisted training model with the at least one first aligned data set, and generate at least one first updated parameter set according to the at least one first parameter set and a first assisted training parameter set of the assisted training model,
wherein the processor further updates the assisted training model with one of the at least one first updated parameter set, and the transceiving interface further transmits one of the at least one first updated parameter set to each of the at least one second source apparatus so that each of the at least one second source apparatus updates the corresponding source model according to the corresponding first updated parameter set,
wherein the at least one source model, the original model, and the assisted training model all conform to a predetermined architecture.

2. The model construction apparatus of claim 1, wherein the transceiving interface further receives a second de-identification data set from each of the at least one first source apparatus and receives a second parameter set of the corresponding source model from each of the at least one second source apparatus,
wherein the processor further generates at least one second aligned data set by aligning the at least one second de-identification data set according to the predetermined data format, trains the updated assisted training model with the at least one second aligned data set, generates at least one second updated parameter set according to the at least one second parameter set and a second assisted training parameter set of the assisted training model, and updates the assisted training model with one of the at least one second updated parameter set,
wherein the transceiving interface further transmits the at least one second updated parameter set to the at least one second source apparatus so that each of the at least one second source apparatus updates the corresponding source model according to the corresponding second updated parameter set.

3. The model construction apparatus of claim 1, wherein each of the at least one first source apparatus generates the corresponding first de-identification data set by performing the following operations:
transforming an original data set into a first coordinate space to generate a first transformed data set, and
taking the first transformed data set as the first de-identification data set.

4. The model construction apparatus of claim 1, wherein each of the at least one first source apparatus generates the corresponding first de-identification data set by performing the following operations:
transforming an original data set into a first coordinate space to generate a first transformed data set,
transforming the first transformed data set into a second coordinate space for a second time to generate a second transformed data set, and
taking the second transformed data set as the first de-identification data set.

5. The model construction apparatus of claim 1, wherein the transceiving interface further transmits the predetermined architecture to each of the at least one second source apparatus.

6. The model construction apparatus of claim 1, wherein each of the at least one first parameter set and each of the at least one first updated parameter set are transmitted between the transceiving interface and the corresponding second source apparatus in an encrypted mode.

7. The model construction apparatus of claim 1, wherein the processor performs the following operations on each of the at least one first de-identification data set:
determining a field name of each of at least one field comprised in the first de-identification data set according to the predetermined data format,
normalizing a plurality of pieces of data comprised in the first de-identification data set according to the predetermined data format, and
aligning a plurality of timestamps of the plurality of pieces of data.

8. A model construction system, comprising:
at least one first source apparatus, wherein each of the at least one first source apparatus has a first de-identification data set;
at least one second source apparatus, wherein each of the at least one second source apparatus has a source model; and
a model construction apparatus, being configured to receive the corresponding first de-identification data set from each of the at least one first source apparatus, receive a first parameter set of the corresponding source model from each of the at least one second source apparatus, generate at least one first aligned data set by aligning the at least one first de-identification data set according to a predetermined data format, train an original model into an assisted training model with the at least one first aligned data set, generate at least one first updated parameter set according to the at least one first parameter set and a first assisted training parameter set of the assisted training model, update the assisted training model with one of the at least one first updated parameter set, and transmit one of the at least one first updated parameter set to each of the at least one second source apparatus,
wherein each of the at least one second source apparatus updates the corresponding source model according to the corresponding first updated parameter set,
wherein the at least one source model, the original model, and the assisted training model all conform to a predetermined architecture.

9. The model construction system of claim 8, wherein the model construction apparatus further receives a second de-identification data set from each of the at least one first source apparatus and receives a second parameter set of the corresponding source model from each of the at least one second source apparatus,
wherein the model construction apparatus further generates at least one second aligned data set by aligning the at least one second de-identification data set according to the predetermined data format, trains the updated assisted training model with the at least one second aligned data set, generates at least one second updated parameter set according to the at least one second parameter set and a second assisted training parameter set of the assisted training model, updates the assisted training model with one of the at least one second updated parameter set, and transmits one of the at least one first updated parameter set to each of the at least one second source apparatus,
wherein each of the at least one second source apparatus updates the corresponding source model according to the corresponding second updated parameter set.

10. The model construction system of claim 8, wherein each of the at least one first source apparatus generates the corresponding first de-identification data set by performing the following operations:
transforming an original data set into a first coordinate space to generate a first transformed data set, and
taking the first transformed data set as the first de-identification data set.

11. The model construction system of claim 8, wherein each of the at least one first source apparatus generates the corresponding first de-identification data set by performing the following operations:
transforming an original data set into a first coordinate space to generate a first transformed data set,
transforming the first transformed data set into a second coordinate space for a second time to generate a second transformed data set, and
taking the second transformed data set as the first de-identification data set.

12. The model construction system of claim 8, wherein the model construction apparatus further transmits the predetermined architecture to each of the at least one second source apparatus.

13. The model construction system of claim 8, wherein each of the at least one first parameter set and each of the at least one first updated parameter set are transmitted between the model construction apparatus and the corresponding second source apparatus in an encrypted mode.

14. The model construction system of claim 8, wherein the model construction apparatus performs the following operations on each of the at least one first de-identification data set:
determining a field name of each of at least one field comprised in the first de-identification data set according to the predetermined data format,
normalizing a plurality of pieces of data comprised in the first de-identification data set according to the predetermined data format, and
aligning a plurality of timestamps of the plurality of pieces of data.

15. A model construction method, comprising:
(a) receiving, by a model construction apparatus, a first de-identification data set from each of at least one first source apparatus;
(b) receiving, by the model construction apparatus, a first parameter set of a source model from each of at least one second source apparatus;
(c) generating, by the model construction apparatus, at least one first aligned data set by aligning the at least one first de-identification data set according to a predetermined data format;
(d) training, by the model construction apparatus, an original model into an assisted training model with the at least one first aligned data set;
(e) generating, by the model construction apparatus, at least one first updated parameter set according to the at least one first parameter set and a first assisted training parameter set of the assisted training model;
(f) updating, by the model construction apparatus, the assisted training model with one of the at least one first updated parameter set;
(g) transmitting, by the model construction apparatus, one of the at least one first updated parameter set to each of the at least one second source apparatus; and
(h) updating, by each of the at least one second source apparatus, the corresponding source model according to the corresponding first updated parameter set,
wherein the at least one source model, the original model, and the assisted training model all conform to a predetermined architecture.

16. The model construction method of claim 15, further comprising:
receiving, by the model construction apparatus, a second de-identification data set from each of the at least one first source apparatus;
receiving, by the model construction apparatus, a second parameter set of the corresponding source model from each of the at least one second source apparatus;
generating, by the model construction apparatus, at least one second aligned data set by aligning the at least one second de-identification data set according to the predetermined data format;
training, by the model construction apparatus, the updated assisted training model with the at least one second aligned data set;
generating, by the model construction apparatus, at least one second updated parameter set according to the at least one second parameter set and a second assisted training parameter set of the assisted training model;
updating, by the model construction apparatus, the assisted training model with one of the at least one second updated parameter set;
transmitting, by the model construction apparatus, one of the at least one first updated parameter set to each of the at least one second source apparatus; and
updating, by each of the at least one second source apparatus, the corresponding source model according to the corresponding second updated parameter set.

17. The model construction method of claim 15, further comprising:
generating, by each of the at least one first source apparatus, the corresponding first de-identification data set by performing the following steps:
transforming an original data set into a first coordinate space to generate a first transformed data set; and
taking the first transformed data set as the first de-identification data set.

18. The model construction method of claim 15, further comprising:
generating, by each of the at least one first source apparatus, the corresponding first de-identification data set by performing the following steps:
transforming an original data set into a first coordinate space to generate a first transformed data set;
transforming the first transformed data set into a second coordinate space for a second time to generate a second transformed data set; and
taking the second transformed data set as the first de-identification data set.

19. The model construction method of claim 15, further comprising the following step:
transmitting, by the model construction apparatus, the predetermined architecture to each of the at least one second source apparatus.

20. The model construction method of claim 15, wherein the step (c) performs the following steps by the model construction apparatus on each of the at least one first de-identification data set:
determining a field name of each of at least one field comprised in the first de-identification data set according to the predetermined data format;
normalizing a plurality of pieces of data comprised in the first de-identification data set according to the predetermined data format; and
aligning a plurality of timestamps of the plurality of pieces of data.
